(19) United States
(12) Patent Application Publication
(10) Pub. No.: US 2001/0054029 A1
(43) Pub. Date: Dec. 20, 2001

(54) System and method of background advertising in web pages

(76) Inventor: Eddie H. Williams, Fountain Hills, AZ (US)

Correspondence Address: Brett A. Carlson, Snell & Wilmer L.L.P., One Arizona Center, 400 East Van Buren, Phoenix, AZ, 85004-2202, US

(21) Appl. No.: 09/879,764

(22) Filed: Jun. 12, 2001

Related U.S. Application Data
(60) Provisional application No. 60/211,907, filed on Jun. 16, 2000.

(51) Int. Cl. G06F 17/60

(52) U.S. Cl. 705/52; 705/14; 707/104.1

(57) ABSTRACT

According to various exemplary embodiments, methods and system for distributing advertising materials suitably include embedding a pointer (such as an HTML body statement and URL) into a document viewed by a user. As the page is processed by the users' browser, the browser follows the pointer to obtain an image or other file from a background server. The file or image may then be viewed by the user as part of the document. Various alternate embodiments include processing by the background server to select and serve an image/file that is variable according to time or a last image viewed, or according to user preferences or interests.

This application claims priority of U.S. Provisional Patent Application Serial No. 60/211,907 filed Jun. 16, 2000.

### FIELD OF THE INVENTION

The invention relates generally to systems and methods for advertising products, services or brands. More particularly, the invention relates to systems for displaying advertising materials on a digital network such as the Internet.

### BACKGROUND OF THE INVENTION

Various forms of advertising have been used for many years. In recent years, much attention has been placed upon “branding” or developing a brand name in the eyes and minds of consumers. Various methods of developing a brand include, inter alia, print advertising, radio and television advertising, product placement in movies and television programs, and promotion via the Internet and other forms of media.

With regard to promotion via digital networks such as the Internet (or any other public or private network), various forms of promotion and advertising have existed for some time. Banner ads, for example, are commonplace on many web sites. Banner ads typically provide an advertising message that a user may read. Many banner ads are considered “live”, “hot” or “clickable” such that users click on the ad to view a world wide web page (or similar information source on the network) that provides more information or allows the user to purchase a good or service described by the banner ad. In practice, however, the success of banner ads has been relatively low since many users simply ignore the ads, or configure their browsers to automatically ignore the ads. Moreover, the instances of “clickthrus” (i.e. viewers clicking on the ad to receive more information or purchase the product described) have been relatively low to date. It is therefore desirable to create a new advertising technique that effectively promotes advertising material and increases brand recognition via digital networks.

### BRIEF SUMMARY OF EXEMPLARY EMBODIMENTS

According to various exemplary embodiments, methods and system for distributing advertising materials suitably include embedding a pointer (such as an HTML body statement and URL) into a document viewed by a user. As the page is processed by the users' browser, the browser follows the pointer to obtain an image or other file from a background server. The file or image may then be viewed by the user as part of the document. Various alternate embodiments include processing by the background server to select and serve an image/file that is variable according to time or a last image viewed, or according to user preferences or interests.

### BRIEF DESCRIPTION OF THE DRAWING FIGURES

The above and other features and advantages are hereinafter described in the following detailed description of illustrative embodiments to be read in conjunction with the accompanying drawing figures, wherein like reference numerals are used to identify the same or similar parts in the similar views, and:

FIG. 1 is a block diagram of an exemplary system for providing advertising information;

FIG. 2 is a flow chart of an exemplary process for providing advertising information; and

FIG. 3 is HTML code from an exemplary web page that incorporates remotely distributed background images.

### DETAILED DESCRIPTION OF EXEMPLARY EMBODIMENTS

Various embodiments of the present invention may be described herein in terms of functional block components and various processing steps. It should be appreciated that such functional blocks may be realized by any number of hardware and/or software components configured to perform the specified functions. For example, the software elements described herein be implemented with any programming or scripting language such as C, C++, PASCAL, Java, assembler, PERL, PHP, HTML, XML, any database programming language or the like, and the various algorithms may be implemented with any combination of data structures, objects, processes, routines or other programming elements. Similarly, the invention could be used in conjunction with any type of personal computer, network computer, workstation, minicomputer, mainframe, or other computer running any version of Windows, MacOS, BeOS, Linux, UNIX, Solaris or any other operating system. Further, the present invention might employ any number of conventional techniques for data transmission, signaling, data processing, network control, and the like. For example, radio frequency (RF) or other wireless techniques could be used in place of any network technique described herein. Moreover, although the invention is frequently described herein as being implemented with TCP/IP communications protocols, it will be readily understood that the invention could also be implemented using IPX, Appletalk, IP3, IP-6, NetBIOS, OSI or any number of existing or future protocols. Further, the term “Internet” may refer to the Internet, any replacement, competitor or successor to the Internet, or any public or private internetwork, intranet or extranet that is based upon open or proprietary protocols. Specific information related to the protocols, standards, and application software utilized by in connection with the Internet may not be discussed herein. For further information regarding such details, see, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997). LOSHIN, TCP/IP CLEARLY EXPLAINED (1997). All of these texts are hereby incorporated by reference. Additionally, the term “web page” as it is used herein is not meant to limit the type of documents and applications that might be used to interact with the user. For example, a typical website might include, in addition to standard HTML documents, various forms, Java applets, Javascript, active server pages (ASP), common gateway interface scripts (CGI), extensible markup language (XML), dynamic HTML, cascading style sheets (CSS), helper applications, plug-ins, and the like.

The particular implementations shown and described herein are illustrative of the invention and are not intended to limit the scope of the invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections might be present in a practical advertising system. To simplify the description of the exemplary embodiments, the invention is frequently described as pertaining to a system of providing backgrounds for web pages. It will be appreciated, however, that many applications of the present invention could be formulated. For example, the present invention could be used to promote or distribute any type of digital content such as advertisements, backgrounds, promotional materials, branding materials, digital images, multimedia content, textual data or the like.

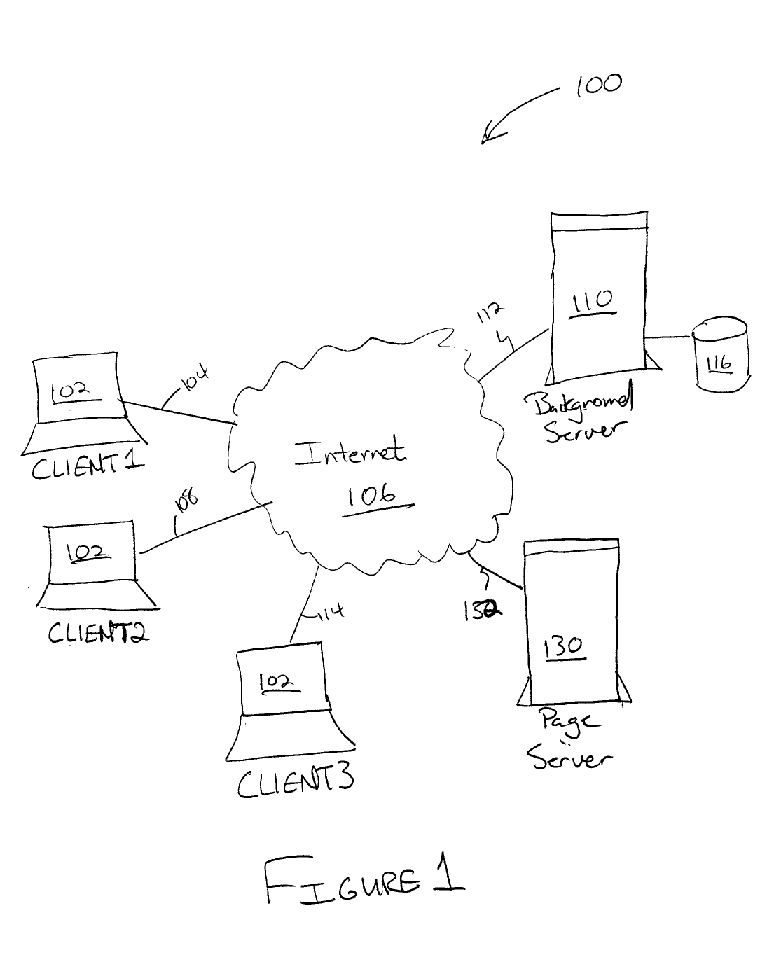

FIG. 1 is a block diagram of an exemplary advertising system 100. With reference to FIG. 1, a number of client systems 102 communicate with a page server system 130 via a network 106 to send and/or receive data, such as HTML documents (i.e. web pages). Page server 130 suitably maintains web pages or other digital content in any conventional manner. In various embodiments, page server 130 includes a conventional HTTP server on the World Wide Web (WWW) that provides content (e.g. web pages) to various client systems 102 via the hypertext transport protocol (HTTP) (or the like) as requested by users of client systems 102. Users suitably view content provided by page server 130 via a conventional browser, or the like, as described below. Of course many page servers 130 may be coupled to network 106, and users of client systems 102 may access web pages and other content from multiple page servers 130.

Content provided by page server 116 may include a pointer or other reference to advertising material (such as background images) from a background server 110. In various embodiments, background server 110 suitably retrieves advertising information as requested by various users in response to the pointers contained in content provided by page server 130, as described more fully below.

User systems 102 may include any convenient combination of hardware and software components configured to allow a user to communicate with over network 106. For example, user system 102 might include a standard personal computer (PC) comprising a CPU, monitor, storage, keyboard, mouse, and communication hardware appropriate for the given data link 104 (e.g., V.90 modem, network card, cable modem, etc.). User system 102 might also include one or more peripheral devices such as a scanner, a digital camera, a motion video camera, a TV Tuner card, or the like. In alternate embodiments, user system 102 is a personal data assistant (PDA) capable of manipulating images and communicating with server 110. In yet another embodiment, user system 102 is a kiosk located at a mall, theme park, post office, street, airport, or any other location.

User systems 102 will typically include an operating system (e.g., Windows NT/95/98/2000, Linux, Solaris, MacOS, PalmOS, etc.) as well as various conventional support software modules and drivers typically associated with computers. User system 102 may also include application software configured to communicate over network 106 with server 110, for example, a World Wide Web (WWW) browser or any other communication software. In an exemplary embodiment, user system 102 includes a conventional Internet browser application that operates in accordance with HTML and HTTP protocols such as Netscape Navigator (available from the Netscape Corporation of Mountain View, Calif.) or Microsoft Internet Explorer (available from the Microsoft Corporation of Redmond, Wash.).

Client systems 102, page server 130 and background server 110 are suitably coupled to network 106 via data links 104, 108, 112 and 114, respectively. A variety of conventional communications media and protocols may be used for data links 104, 108, 112 and 114. Such links might include, for example, a connection to an Internet Service Provider (ISP) over a local loop as is typically used in connection with standard modem communication, cable modem, Dish networks, ISDN, Digital Subscriber Line (DSL), or various wireless communication methods. User system 102 might also reside within a local area network (LAN) which interfaces to network 106 via a leased line (T1, D3, etc.). Such communication methods are well known in the art, and are covered in a variety of standard texts. See, e.g., GILBERT HELD, UNDERSTANDING DATA COMMUNICATIONS (1996), hereby incorporated by reference.

Background server 110 comprises any number of hardware, software, and networking components necessary to provide a suitable website or other network-based graphical user interface that is accessible by users, and which provides the functionality described in further detail below. In one embodiment, Sun Ultra SPARC Enterprise 250 and 450 servers are used in conjunction with a Sun Solaris 7 or Linux operating system, Apache web server software, and an Oracle 8 or MySQL database system. Of course particular hardware and software components used in server 110 will vary widely from embodiment to embodiment. Furthermore, server 110 may represent a “cluster” or group of separate computer systems providing the functionalities described herein. In various embodiments, server 110 includes a suitable interface to network 106 such as a network interface card (NIC) and/or appropriate data networking software such as an implementation of the TCP/IP stack, or the like. Of course, server 110 is not necessarily directly connected to network 106, but may be coupled to network 106 though any system of cabling, bridges, routers, gateways, data links, and the like.

Server 110 may suitably maintain background files and other advertising content in a database 116. Database 116 may be a graphical, hierarchical, relational, object-oriented or other database, and may be maintained on a local drive of server 110 or on a separate computer coupled to server 110 via a local area or other network (not shown). Content may be suitably retrieved from database 116 and provided to user systems 102 upon request via a server software application, as described more fully below. In alternate embodiments, database 116 is represented by a collection of files stored on a local drive of server 110. Files of advertising materials may be stored within a directory created under an appropriate file system for server 110 in addition to or in place of storage in database 116. In an exemplary embodiment, the particular directory selected for storage of advertising materials may be within the directories made available via network 106 by a HTTP server or similar program executing at server 130 (see below). Advertising materials may be stored in any format, such as text, graphics interchange file (GIF), compressed or uncompressed tagged image format file (TIFF), PNG files, MPEG files, JPG files, or any other suitable format. Alternatively, advertising material may be stored in any form of textual, graphical, audio, video or multimedia file format.

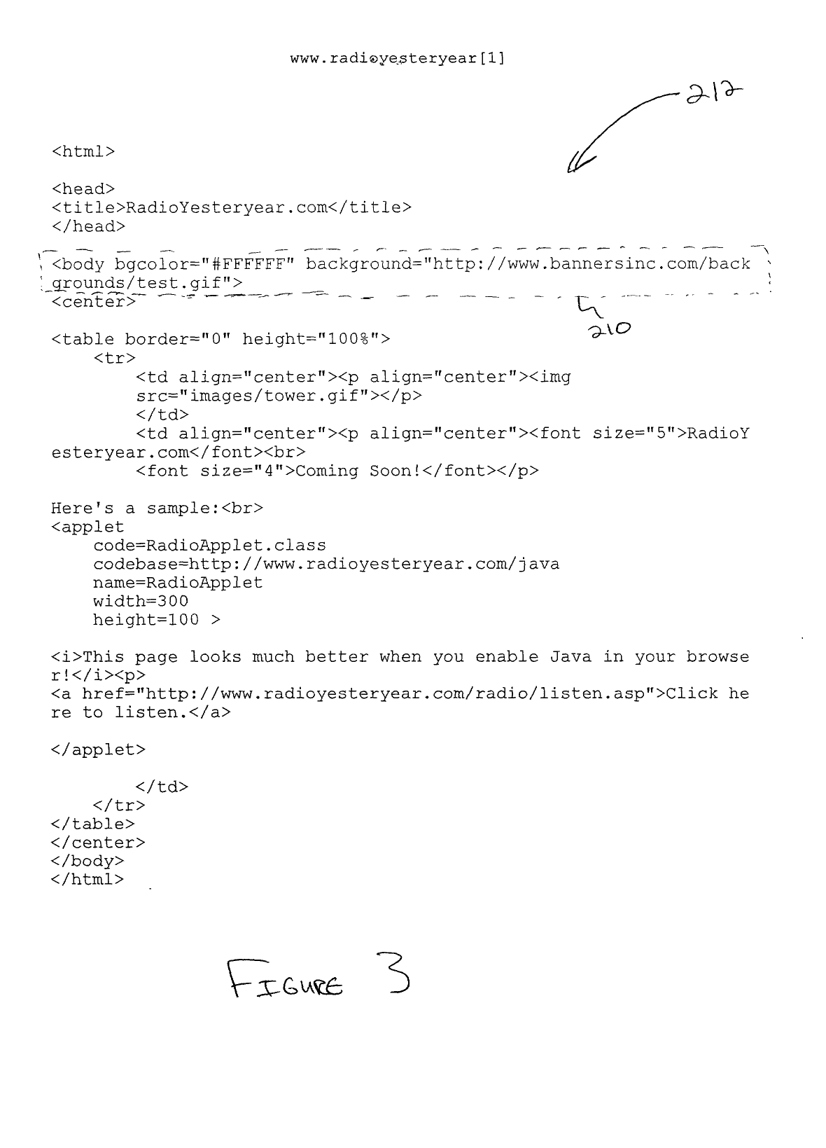

Page server 130 and background server 110 may be configured as a conventional Internet or WWW servers that provides data via the hypertext transport protocol (HTTP). The data may include a pointer to a file that may be viewed as a background image of the data in the user's browser. In various embodiments, pages served by page server 130 include hypertext markup language (HTML) “body” statements that include a uniform resource locator (URL) identifying a file on background server 110 (see FIG. 3), although of course other types of links or pointers could be used. Such a URL may include a filename, directory path or other information suitable to identify a particular file on server 130. As will be appreciated, browsers or other viewer programs executing on client systems 102 suitably format web pages that include data from various sources. As such, the browser program at client system 102 suitably retrieves a background image from background server 110 by following the pointer embedded in the web page or other content received from page server 130. By following the pointer (e.g. the URL contained within the body tag/link), the user's browser is directed to the appropriate file available from background server 110, which may be incorporated into the viewed page using, for example, conventional HTML techniques. In various embodiments, page server 130 is and background server 110 coincide as logical processes executing a single server machine. In other exemplary embodiments, page server 130 and background server 100 reside on separate host systems interconnected by network 106.

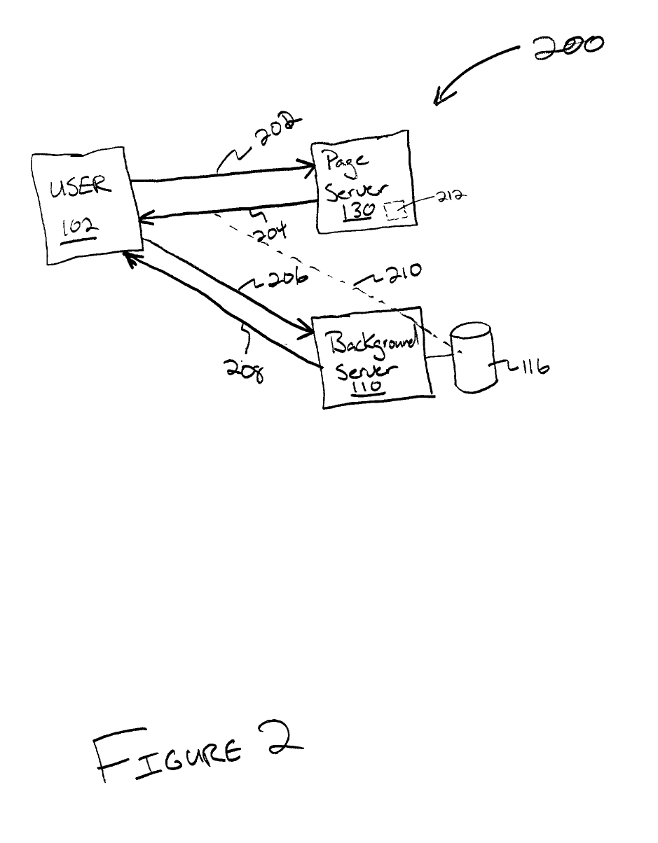

FIG. 2 is data flow diagram of an exemplary technique 200 for providing advertising information to a viewer via a network 106. It will be appreciated that the various message sent in conjunction with technique 200 may be any type of network communication, but in an exemplary embodiment messages 202, 204, 206 and 208 are HTTP messages embedded within conventional TCP/IP transport, session and data link packets. Pages of information viewed may be HTML documents, web pages, or any other type of document or page. With reference now to FIG. 2, a user with access to a client computer 102 suitably contacts page server 130 (message 202) to request a page to be viewed. The particular page 212 requested may be identified by, for example, a URL or other identifier contained in message 202. Page 212 is suitably maintained (e.g. stored or otherwise accessed) on page server 130, which suitably receives request message 202, retrieves the requested page 212 and provides page 212 to client/user 102. An exemplary page 212 in HTML format is shown in FIG. 3. In various embodiments, page 212 suitably includes a pointer 210 to a background image or other file maintained on background server 130, as described above. Client system 102 may then suitably receive page 212 via message 204 from page server 130, and may retrieve the desired image/file from background server 110 (message 206) by following pointer 210 in page 212. In various embodiments (such as the embodiment shown in FIG. 3), pointer 210 is an HTML ‘body” tag that references an HTML uniform resource locator (URL). The URL suitably assigns and transmits a background image (or other content) that can be displayed in a conventional browser.

Background server 110 suitably receives background request message 206 and retrieves the referenced file, background, image or other file as appropriate (e.g. from local or remote storage, or from database 116). The advertising/background file may then be returned to client system 102 (message 208) and viewed or otherwise processed as appropriate. Other types of pointers (such as XML tags or other data constructs) may be used in alternate embodiments. Content may be assigned statically or dynamically in that the same images may be provided to the same pages for all requests, or different images may be provided at different times or according to various criteria, as set forth below.

In various embodiments, the particular background image sent to various clients may be dependent upon various processing at background server 110. For example, message 206 may contain an identifier (such as an Internet Protocol (IP) address, a cookie, or another identifier) that contains information about a particular viewer/user. This information may be used to determine a background provided to the particular viewer. For example, if it is known that the user has visited a number of web sites related to motorsports, a background promoting an automobile manufacturer may be provided. Similarly, if it is known (from observation of cookies, database information, or the like) that the particular user sending message 206 is interested in football, a background having a local sports team logo could be provided. Of course many different applications of the invention could be formulated corresponding to various forms of information that may be available about the particular user and the types of backgrounds or other files available.

Further embodiments of the invention may include information about users in database 116 or a separate database accessible from server 110. In such embodiments, user “surfing” habits may be tracked using cookies or the like. A cookie or other identifier may be stored on client system 102, for example, as part of message 208. Subsequent requests 206 for background information from that particular client system 102 may then provide the cookie back to server 110 such that a background requests are monitored and/or stored in database 116. Such a system could be used to maintain a common background image on client computer 102's browser even as the user surfs to various web sites, and/or it could be used to gather information about the particular surfing habits of the user such that backgrounds may be customized. Cookies, for example may be data files that are stored on a user's machine to record a “history” of web pages visited. These cookies may be provided to background server 110 or another web server to evaluate the pages visited by the user and to suggest a background image that would be interesting to that user based upon that historical information. Alternatively, requests for images may be recorded in a database in conjunction with an IP address or other identifier corresponding to the user requesting the information. By monitoring the pointers provided by various users, the sites frequented by those users can be identified, and advertising material can be selected to match that users' interests.

Further embodiments allow rotation of background images by user, according to periods of time, or otherwise. In such embodiments, background server 110 could be configured such that the particular file referenced by pointer 212 varies over time or in response to the particular user request 206. For example, if pointer 212 is a URL reference to a file names “background.gif” on server 110, server 110 may be programmed (with UNIX/LINUX “cron” statements or PERL scripts, for example) to rename various files as “background.gif” such that a desired background is provided at a given time, or such that a desired succession of background images may be presented. For example, an automotive logo could be used for a first background, a sports team logo could be used for a second background, and a restaurant logo could be used for a third background. Each of these three exemplary backgrounds could be rotated as “background.gif” on a time of day (e.g. hourly, daily, weekly, monthly, etc.), sequential or other basis. Alternatively, each user could receive a different background each time web page 212 is received. Further, it should be noted that a single background server 110 may support many different page servers 130 such that the same background is provided to web pages emanating from each server, or with each server having its own background image, or the like. To facilitate such a system, pages 212 are suitably formatted with unique pointers 210 to particular files stored on server 110. If the pointers are URLs provided within HTML “body” statements, for example, a separate URL pointing to a desired file could be used. Of course many other embodiments could be formulated to include multiple servers, clients, pointers and background images/advertising materials.

No elements of the invention described herein are essential to the practice of the invention unless specifically described herein as “essential” or “required”. Of course other embodiments and applications of the system and technique may be formulated without departing from the scope of the present invention. The corresponding structures, materials, acts and equivalents of all elements in the claims below are intended to include any structure, material or acts for performing the functions in combination with other claimed elements as specifically claimed. The scope of the invention should be determined by the appended claims and their legal equivalents, rather than by the examples given above. The steps recited in any method claims may be practiced in the order recited, or in any other order.

What is claimed is:

1. A system for providing advertising information to a viewer on a digital network, the system comprising:
a network interface configured to transmit and receive data on said digital network;
a database comprising said advertising information; and
software code configured to receive requests for said advertising information from said viewer via said network interface and to provide said advertising information via said network interface in response to said requests.

2. The system of claim 1 wherein said requests are generated by a pointer to said advertising information stored in a network document retrieved from a remote source by said viewer.

3. The system of claim 2 wherein said pointer comprises an HTML body tag.

4. The system of claim 2 wherein said software code is further configured to obtain user information and to select said advertising information based upon said user information.

5. The system of claim 4 wherein said user information comprises a cookie.

6. The system of claim 2 wherein said advertising information is selected based upon time.

7. The system of claim 2 wherein said advertising information is selected based upon a sequence of images in said advertising information.

8. The system of claim 2 wherein said advertising information comprises graphics files.

9. The system of claim 8 wherein said pointer comprises a uniform resource locator (URL).

10. A method of providing advertising information to a user via a digital network, the method comprising the steps of:
obtaining said pointer at a server from said user via said digital network, wherein said pointer is obtained by said user from a network document;
processing said pointer at said server to retrieve desired advertising information; and
providing said advertising information to said user for viewing with said network document.

11. The method of claim 9 wherein said pointer comprises an HTML body statement.

12. The method of claim 9 wherein said pointer comprises a uniform resource locator (URL).

13. The method of claim 10 further comprising the step of obtaining a cookie from said user.

14. The method of claim 13 wherein said processing step further comprises evaluating said cookie to determine said desired advertising material.

15. The method of claim 10 wherein said processing step further comprises selecting said desired advertising material based upon time.

16. The method of claim 10 wherein said processing step further comprises selecting said desired advertising material based upon user interests.
